(19) United States
(12) Patent Application Publication
(10) Pub. No.: US 2025/0072326 A1
(43) Pub. Date: Mar. 6, 2025

(54) FORAGE HARVESTER AND METHOD FOR OPERATING A FORAGE HARVESTER

(71) Applicant: CLAAS Selbstfahrende Erntemaschinen GmbH, Harsewinkel (DE)

(72) Inventors: Dennis Neitemeier, Lippetal (DE); Sven Carsten Belau, Gütersloh (DE); Ingo Bönig, Gütersloh (DE); Markus Brune, Harsewinkel (DE); Marwin Klein Helmkamp, Bramsche (DE); Johann Witte, Fröndenberg (DE)

(73) Assignee: CLAAS Selbstfahrende Erntemaschinen GmbH, Harsewinkel (DE)

(21) Appl. No.: 18/822,689

(22) Filed: Sep. 3, 2024

(30) Foreign Application Priority Data
Sep. 1, 2023 (DE) 102023123659.8

(51) Int. Cl. A01D 43/08; G06T 7/00; G06T 7/60

(52) U.S. Cl. CPC A01D 43/085; A01D 43/081; G06T 7/0002; G06T 7/60; G06T 2207/30188

(57) ABSTRACT

A self-propelled forage harvester, a method for operating a forage harvester, and computer readable medium to perform the method for operating the forage harvester. The forage harvester includes a cutterhead driven at a variable rotational speed (n_{HT}) for chopping harvested material, a cracker roller pair with a variable gap width positioned behind the cutterhead on a path of the harvested material through the forage harvester for comminuting grains in the chopped harvested material, and a control unit for controlling the rotational speed and the gap width. The control unit is part of a setting device controlled using a characteristic map, wherein the characteristic map describes or is indicative of a corn silage processing score (CSPS) depending on at least the rotational speed and the gap width.

### CROSS REFERENCE TO RELATED APPLICATION

This application claims priority under 35 U.S.C. § 119 to German Patent Application No. DE 10 2023 123 659.8 filed Sep. 1, 2023, the entire disclosure of which is hereby incorporated by reference herein.

### TECHNICAL FIELD

The present invention relates to a forage harvester, a method for operating a forage harvester, and a computer program product, such as a computer readable medium which may be used in the forage harvester or for performing the method.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

In the operation of a forage harvester, one should strike a balance between the requirements of breaking down the nutrients contained in the harvested material in such a way that they may be easily and completely utilized by livestock fed with the comminuted harvested material, and time and energy-efficient harvesting operation. On the one hand, grains contained in the harvested material should be comminuted to such an extent that they may be easily digested; on the other hand, as little time and drive energy as possible should be used for comminution.

The corn silage processing score (CSPS) has been defined to quantify the suitability of corn chaff as livestock feed. The CSPS may be defined as a function of the size distribution of fiber and starch particles in feed material and may be conventionally measured by sieving methods that are performed with the finished feed.

US Patent Application Publication No. 2022/0071091 A1, incorporated by reference herein in its entirety, discloses a forage harvester in which operating variables relevant to the comminuting result, such as cutterhead speed, cracker gap width or rotational speed difference of the cracker rollers, are linked to a processing quality using a characteristic map so that suitable values of these operating variables may be determined and set for a specified processing quality using the characteristic map.

US Patent Application Publication No. 2019/0261559 A1, incorporated by reference herein in its entirety, describes a forage harvester in which the variable to be set using a characteristic map is the compactability of the comminuted material.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a side view of an example forage harvester.

FIG. 2 illustrates a section of an image captured by a camera of the forage harvester.

FIG. 3 illustrates an example characteristic diagram.

FIG. 4 illustrates a diagram of a database on which the calculation of the characteristic map by an on-board computer of the forage harvester may be based.

### DETAILED DESCRIPTION

As discussed in the background, US Patent Application Publication No. 2022/0071091 A1, discloses a forage harvester in which operating variables relevant to the comminuting result are linked to a processing quality using a characteristic map so that suitable values of these operating variables may be determined and set for a specified processing quality using the characteristic map. However, a definition of the processing quality is not given.

In one or some embodiments, a self-propelled forage harvester is disclosed that is configured to produce nutritionally valuable comminuted material with minimum time and energy input.

In one or some embodiments, the self-propelled forage harvester includes a cutterhead driven at a variable rotational speed for chopping harvested material, a cracker roller pair with a variable gap width arranged or positioned behind the cutterhead on a path of the harvested material through the forage harvester for comminuting grains in the chopped harvested material, and a control unit configured to control the rotational speed and the gap width, in that the control unit is part of a setting device controlled by means of a characteristic map, wherein the characteristic map describes a corn silage processing score, CSPS, depending on at least the rotational speed and the gap width. In this regard, the control unit is configured to: automatically access a characteristic map (CF), wherein the characteristic map describes a corn silage processing score (CSPS) depending on at least the rotational speed (n_{HT}) and the gap width (CC); automatically determine, based on the characteristic map, a value for the rotational speed and a value for the gap width; and automatically control the cutterhead to operate at the value for the rotational speed and the cracker roller pair to operate at the value for the gap width. In this regard, the control unit may be operated to automatically set the rotational speed and the gap width to match a target value of the CSPS using the characteristic map.

Responsive to the control unit automatically detecting a significant deviation between the target value and actual value of the CSPS (e.g., a predetermined deviation that is greater than or equal to a predetermined percentage), the control unit may automatically adjust an operating variable to reduce the deviation (e.g., send a command in order to make the automatic adjustment). Due to the high inertia of the cutterhead, an adjustment of its speed may be energy-intensive and should be avoided even if it could be set arbitrarily. In practice, however, it is common for the rotational speed of the drum to be permanently coupled to that of the motor, so that if the motor is to be run at the optimum of its speed-torque characteristic, the drum rotational speed may thereby be fixed. Therefore, in one or some embodiments, the control unit may first automatically attempt to counteract the deviation by automatically changing the gap width in a direction for which a reduction in the deviation may be expected based on the characteristic map, and control unit may automatically change the rotational speed only responsive to automatically determining that the gap width cannot be changed any further because the gap width has reached the limit of its setting range.

Measuring the CSPS using conventional sieving tests may be too time-consuming for the settings of the forage harvester to be feasible on the basis of the obtained results. Since the properties of the harvested material may change during the course of a harvesting operation (e.g., due to varying soil conditions), it may be hardly practical to adjust the settings of the forage harvester in ongoing operation in this way. For this reason, an image processing unit may be connected to a camera arranged or positioned in the path of the harvested material arranged or positioned behind the cracker roller pair in order to automatically determine an actual value of the CSPS from images of the harvested material supplied by the camera.

In particular, the image processing unit may be configured to automatically determine at least one dimension of particles depicted in the images and, using the at least one dimension, to decide or determine the affiliation or correlation of the particle with a size fraction relevant for determining the actual value of the CSPS. In other words, the need for mechanical sieving may be eliminated by automatically deciding or detecting by calculation which sieve fraction the particles of the harvested material would have ended up in. In this way, an actual value of the CSPS may be determined more quickly, such as on the order of seconds or fractions of a second, that it may be assumed that the resulting corrections to the gap width and rotational speed are still appropriate for the harvested material collected at the time of the correction.

The CSPS value achieved by the setting device during operation may depend on any one, any combination, or all of: the rotational speed; the gap width; the nature of the harvested material (which may vary depending on the variety and location of the harvested material); or on climate conditions during growth. In this regard, a characteristic map that has once enabled a good prediction of the CSPS value at a given location does not necessarily have to do so when used at another location or even at the same location in another year. Therefore, the control unit may be able to automatically optimize the characteristic map on the basis of deviations between a CSPS value predicted by the characteristic map for a value pair of rotational speed and gap width and a CSPS value measured for the value pair, in order to thereby enable a satisfactory prediction of the CSPS value for a different location or a different harvest year.

To ensure that only significant measured values are included in the optimization, in one or some embodiments, only a CSPS value measured during a quasi-stationary state of the forage harvester is used for the optimization. The state of the forage harvester may be considered to be quasi-stationary if, in a predetermined or specified period of time which may be longer than the dwell time of the harvested material in the forage harvester, changes in the rotational speed, the gap width and the CSPS value are smaller than a predetermined relative fluctuation range (e.g., if it may be assumed that the currently measurable CSPS value is also equal with sufficient accuracy to that which is achieved at the same time by the cutterhead and cracker rollers of the forage harvester). In one or some embodiments, the specified relative fluctuation range may, for example, be less than or equal to 10%, less than or equal to 5%, less than or equal to 4%, less than or equal to 3%, less than or equal to 2%, less than or equal to 1%.

In one or some embodiments, the characteristic map may be defined by a multi-parameter function of any two or more of: the rotational speed; the gap width; or a set of values of the parameters of the multi-parameter function. This may allow for the characteristic map to be updated by changing the parameter values to adapt to changed properties of the harvested material based on a small number of pairs of values, each comprising (or consisting of) a value of the CSPS expected from the characteristic map for the given values of rotational speed and gap width and an actual value of the CSPS measured at these values.

An optimization unit may be configured to automatically optimize the set of parameter values based on a database of value pairs of the rotational speed and the gap width and CSPS values measured for these value pairs with the aim of reducing or minimizing a deviation between an actual value of the CSPS and a value of the CSPS expected on the basis of the characteristic map.

The database may comprise (or consist of) solely CSPS values collected during the course of use of the forage harvester and the associated pairs of values for rotational speed and gap width. In one or some embodiments, however, the database may also include data saved in advance and already available before the start of operation. By including these in the optimization of the set of parameters, the statistical basis of the optimization may be broadened, and sharp fluctuations in parameter values determined in the optimization may be avoided, such as in an initial phase of use.

On the other hand, it may be ensured that the previously saved data does not permanently falsify the result of the optimization if it is no longer up-to-date. For this purpose, it may be provided that the value pairs of the data-base define a point grid in a two-dimensional setting range defined by the values that the rotational speed and the gap width may assume during operation, and that, responsive to determining that a measured CSPS value is available for a value pair of rotational speed (n_{HT}) and gap width (CC) that does not correspond to any point of the grid, the point of the grid closest to this value pair is determined, and the CSPS value of the database assigned to this point is overwritten using the measured CSPS value.

In one or some embodiments, the multi-parameter function is a second-order polynomial that has the rotational speed and the gap width as variables. Higher order polynomials are also contemplated, but the time required to adjust the parameter values increases with the order of the polynomial since the number of value pairs of expected and measured values of the CSPS that are required for a fit of the parameter values increases sharply with the order of the polynomial.

To ensure that old pairs of values that no longer correspond to the current properties of the harvested material do not distort the result of the optimization, the weighting with which pairs of measured and expected values of the CSPS are included in the optimization may decrease with the age of the pairs.

If the number of available value pairs of measured and expected values of the CSPS is smaller than the number of parameters of the multi-parameter function, this does not necessarily mean that optimization is impossible, but merely that there may be a large number of sets of parameter values for which the difference between the measured and expected value disappears. One of these sets may certainly be used for optimization. In this regard, an initial optimization may be performed responsive to determining that the number of available value pairs of measured and expected values of the CSPS is smaller than the number of parameters of the multi-parameter function.

In one or some embodiments, a method for operating a forage harvester, such as the forage harvester as described above, is disclosed. The method comprises:
automatically providing or automatically accessing a multi-parameter function of any one, any combination, or all of the rotational speed of a cutterhead, the gap width of a cracker gap, or an original set of parameter values, which may define an original characteristic map of the CSPS depending on at least the rotational speed and the gap width;
automatically determining an actual value of the CSPS for actual values of the rotational speed and the gap width;
automatically replacing the original set of parameter values with an optimized set, wherein the parameter values of the optimized set are selected such that the deviation between the actual value of the CSPS and a set expected on the basis of the characteristic map is smaller when using the optimized parameter values than when using the original parameter values.

In one or some embodiments, in addition to the rotational speed and the gap width, the characteristic map may also depend on other operating variables of the forage harvester such as a speed difference between the rollers of the cracker gap, and that parameters of the multi-parameter function linked to these other operating variables may also be the subject of the optimization. Here too, however, it may be desirable not to let the number of operating variables become excessive in order to obtain an optimization result in a shorter time.

In one or some embodiments, a computer program product, such as a non-transitory or non-transient computer readable medium, that comprises executable or program instructions (e.g., a tangible and/or non-transitory computer-readable recording medium storing instructions) which, when executed by a computer, enable it to operate as any one, any combination, or all of: a control unit (with any or all of the functionality described herein); an optimization unit (with any or all of the functionality described herein); or image processing unit (with any or all of the functionality described herein), in a forage harvester as described above or to execute the method described above. In this regards, the computer-readable medium may store instructions that, when executed by a computer, cause it to perform part or all of the method described herein.

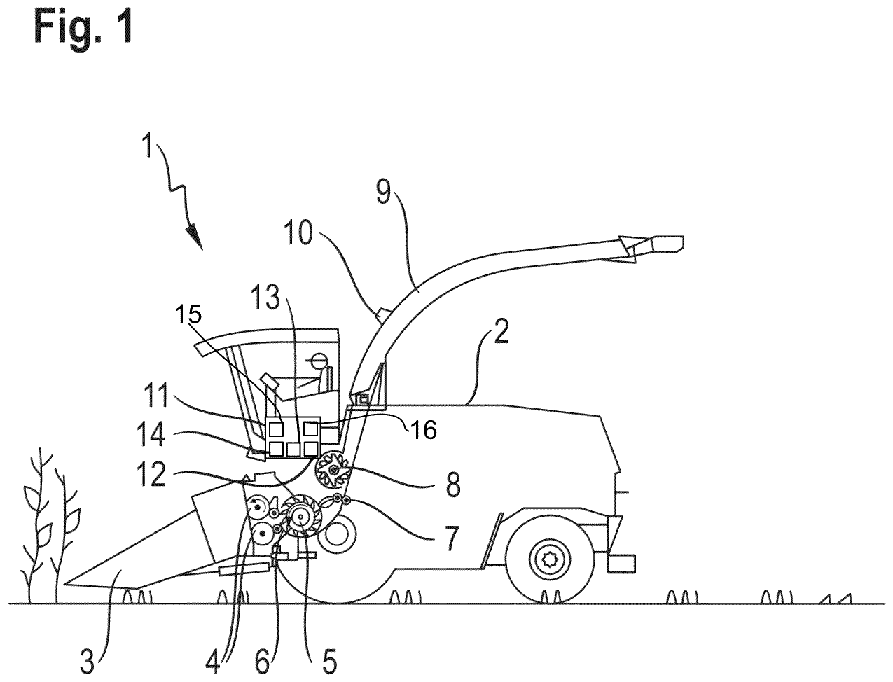

Referring to the figures, FIG. 1 shows a partially transparent side view of a forage harvester 1. Example forage harvesters include US Patent Application Publication No. 2023/0232740 A1 and US Patent Application Publication No. 2024/0196796 A1, both of which are incorporated by reference herein in their entirety. The forage harvester may have a rigid body 2 to which an attachment 3, such as a corn header, is attached in a height-adjustable manner. The harvested material cut and collected by the attachment 3 may be compacted by a pair of feed rollers 4 and fed to a cutting mechanism in which a rotating cutterhead 5, in conjunction with a stationary cutting edge 6, chops the harvested material. The length of the obtained chopped particles may be proportional to the ratio of the rotational speeds of the pair of feed rollers 4 and the cutterhead 5.

On the path of the harvested material through the forage harvester 1, a pair of cracker rollers 7, which may be driven at different circumferential speeds, follow the cutting mechanism in a manner known per se in order to comminute the grains contained in the chopped material. The width of a gap between the cracker rollers 7 may be adjustable and may determine the size of the grain fragments obtained at the exit of the gap.

A post-accelerator 8 following the cracker rollers 7 may be used to accelerate the comminuted material to the speed required to pass through a discharge chute 9.

A camera 10 may be arranged or positioned along the path of the harvested material downstream from the cracker rollers 7 in order to capture one or more images of the comminuted material. In contrast to the depiction in FIG. 1, the camera 10 may be arranged or positioned upstream from the post-accelerator 8; its placement downstream, such as at the discharge chute 9, may have the advantage that the density of the particles in the stream of comminuted material is reduced there so that individual particles are easier to identify in the images, and the probability may be reduced that particles overlap and therefore their size cannot be reliably assessed.

The camera 10 may be in communication with (e.g., wired and/or wireless communication) an image processing unit 12 in an on-board computer 11 of the forage harvester 1. On-board computer 11 may include at least one processor 15 and at least one memory 16. The at least one processor 15 and at least one memory 16 may be in communication with one another. In one or some embodiments, the processor 15 may comprise a microprocessor, controller, PLA, or the like. Similarly, the memory 16 may comprise any type of storage device (e.g., any type of memory). Though the processor 15 and the memory 16 are depicted as separate elements, they may be part of a single machine, which includes a microprocessor (or other type of controller) and a memory. Alternatively, the processor 15 may rely on the memory 16 for all of its memory needs. The memory 16 may comprise a tangible computer-readable medium that include software that, when executed by the processor 15 is configured to perform any one, any combination, or all of the functionality described herein regarding any computing device.

The processor 15 and the memory 16 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Image processing unit 12, optimization unit 13, and control unit 14 may reside within on-board computer 11, as depicted in FIG. 1. In one or some embodiments, each of image processing unit 12, optimization unit 13, and control unit 14 may comprise different computer threads that operate within on-board computer 11. Alternatively, one, some, or each of image processing unit 12, optimization unit 13, and control unit 14 may reside within a separate computer and may be in communication (e.g., wired and/or wirelessly) with a remainder of the image processing unit 12, optimization unit 13, and control unit 14.

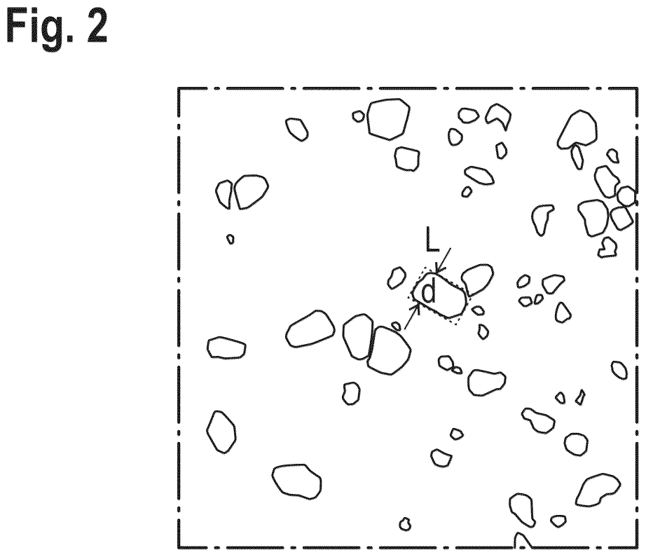

In one or some embodiments, the image processing unit 12 is programmed to identify grains and grain fragments in the images from the camera 10. FIG. 2 shows the result of such an identification: Each pixel of the image may be assigned one of two values, depending on whether or not the pixel shows a grain or grain fragment. In FIG. 2, grains and grain fragments are shown in white against a black background.

In a subsequent step, the image processing unit 12 is configured to determine for each identified grain or grain fragment a direction L of its smallest dimension d as illustrated in FIG. 2 in an example and, using a known image scale of the camera 10, the amount or value of this dimension d in order to decide on the basis of the result (e.g., the value of the dimension d) whether or not the grain or grain fragment could have passed through a sieve with a mesh size prescribed for the experimental determination of the CSPS. Accordingly, some or all grains or grain fragments in an image or series of consecutive images may be assigned to one of several size fractions, and the thickness of each fraction may be calculated based on the mass of the particles assigned thereto. The assignment of a CSPS reading to the thicknesses obtained in this way may follow the same rules as if the fractions had been obtained conventionally by physical sieving and then weighed, and therefore need not be explained further here.

Even if it is not known exactly how the CSPS value achieved during comminuting depends on the rotational speed n_{HT} of the cutterhead 5 and the width CC of the gap between the cracker rollers 7, it may be assumed that it may be approximated by a Taylor series in two dimensions, for example that:

$$CSPS ( CC , {n}_{H T} ) = {p}_{0} + {p}_{1} C C + {p}_{2} {n}_{H T} + {p}_{3} C {C}^{2} + {p}_{4} C C {n}_{H T} + {p}_{5} {n\_HT}^{2}$$

is a good approximation, where p₀, . . . , p₅ are empirical parameters whose values may change depending on the characteristics of the harvested material. Parameter values p₀*, . . . , p₅* determined by the manufacturer for normal harvested materials or that considered to be normal may therefore be saved in the memory 16 of the on-board computer 11 in order to automatically find and automatically set suitable values of CC and n_{HT} for a desired CPPS value of the harvested material at the start of a harvesting operation; however, it may be assumed that the CSPS value actually realized with the values of CC and n_{HT} found in this way may deviate from the desired value, and that CC and n_{HT} may have to be adjusted on the basis of the observed deviation in order to achieve the desired value. In one or some embodiments, optimization unit 13 of the on-board computer 11 is tasked with automatically performing this adjustment; control unit 14 may be configured to automatically control the rotational speed of a motor driving the cutterhead 5 and the width of a cracker gap between the cracker rollers 7 (e.g., automatically send a command to the cutterhead 5 with the value of the rotational speed of the motor driving the cutterhead 5 in order for the cutterhead 5 to automatically perform the adjustment; automatically send a command with the value of the width of the cracker gap between the cracker rollers 7 to automatically perform the adjustment). In other words, the control unit 14, together with the cutterhead and the cracker gap as a harvested material treatment device and the camera 10 as sensor, may form an adjusting device (such as an automatic adjustment device) as disclosed in US Patent Application Publication No. 2019/0289787 A1, incorporated by reference herein in its entirety.

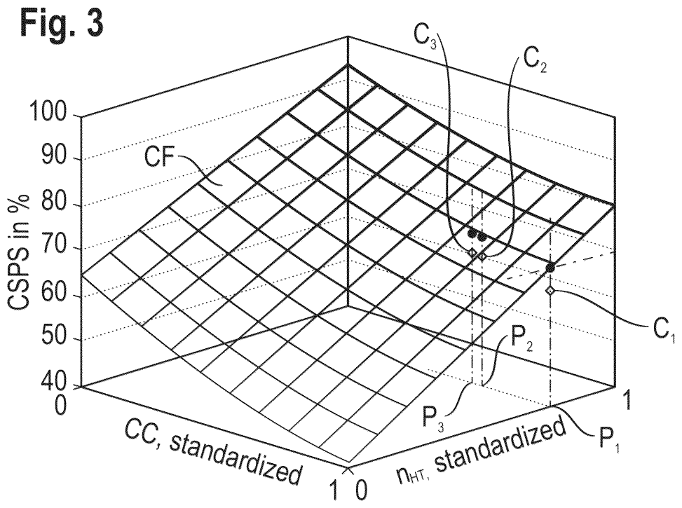

An example method is disclosed with reference to FIG. 3. Specifically, FIG. 3 shows an exemplary characteristic map CF for the CSPS, automatically calculated by the on-board computer 11 as a function of the rotational speed n_{HT} and the gap width CC using the above formula based on the parameter values p₀*, . . . , p₅* specified by the manufacturer. In one or some embodiments, for good processing, the CSPS of the harvested material should reach at least 70%; this value may therefore be set as the target value for the CSPS, and a value pair P₁=(n_{HT}, CC) of rotational speed and gap width is automatically set for the start of a harvesting operation, for which CSPS (n_{HT}, CC)=70%.

Since the harvested material processed in the relevant harvesting operation may be different from that in which the parameter values p₀*, . . . , p₅* were determined, it is to be expected that the measured value CSPS (P₁) automatically determined by the image processing unit 12, which may be obtained during the operation of the forage harvester with the setting P₁, may deviate from the expected 70% and is, for example, 65%, shown in FIG. 3 as diamond C₁.

To still achieve the desired CSPS value, the on-board computer 11 may automatically reduce the gap width CC. For this purpose, the on-board computer 11 may automatically calculate the difference between the target value (70%) and the actual value (65%) of the CSPS, automatically add it to the target value in order to obtain a new target value (75%) and automatically determine a new setting P₂ at which CSPS (P₂)=75%. If such a setting P₂ exists, which may differ from P₁ only in the gap width CC, then this may be automatically selected and automatically set; if necessary, n_{HT} may also be automatically adjusted. In one or some embodiments, it may be expected that the resulting CSPS value C2 is considerably closer to the target value of 70% than C₁.

A remaining difference between the target value and actual value (measured value) may be further automatically reduced by again automatically determining and automatically setting a new setting P₃ as described above. A resulting CSPS value C₃ may be automatically measured; this may provide three support points that allow the parameters p₀, p₁, p₃, which describe the dependence of the CSPS value on the gap width CC, to be automatically recalculated for the current harvested material. By automatically substituting the new values obtained in this way for the original ones in the above formula, an updated characteristic map may be automatically obtained that reflects the current true relationship between CSPS and CC more accurately than the original one.

If more than three measured values of the CSPS are available at the same rotational speed n_{HT} and different gap widths CC, it is generally no longer possible to find parameter value p₀, p₁, p₃ that exactly reproduce the measured values; in this case, the on-board computer 11 may automatically select as parameter values p₀, p₁, p₃ those that reproduce the measured values with minimum squared deviation. Calculation methods for this, also known as the least squares fit, are generally known.

The fact that the measured values C₁, C₂, C₃ may not allow an updating of the other parameters p₂, p₄, p₅ describing the influence of the rotational speed n_{HT} is not a disadvantage as long as the rotational speed n_{HT} does not need to be changed. As soon as this happens, however, measured values of the CSPS may inevitably be automatically obtained that allow a conclusion about or a determination of these parameters.

In fact, the extensive independence of the parameters p₂, p₄, p₅ from the measured values C₁, C₂, C₃ recorded at the same rotational speed may allow a simplification of the structure of the control unit 14 to be simplified: instead of a single control unit for controlling both the rotational speed n_{HT} and the gap width CC, two control units may be provided, one for the gap width CC and the other for the rotational speed n_{HT}. As long as the rotational speed n_{HT} is kept constant, only the control unit for the gap width may optimize the parameters p₀, p₁, p₃ assigned thereto, wherein it treats the other parameters as p₂, p₄, p₅ as external information that is to be taken into account when establishing the gap width. If a changed value of the rotational speed is also set later, then to automatically adjust the characteristic map to the CSPS value observed for this changed rotational speed, it may be sufficient for the control unit 14 for the rotational speed to automatically adjust the parameter p₂, while p₀, p₁, p₃ represent external information that may be taken into account but cannot be changed by the control unit 14 for the rotational speed. If measurement results for the CSPS are available for more than two rotational speed values, the control unit 14 for the rotational speed may also automatically adapt p₄ and p₅ to the measurement results, but may remain without influence (or change) on the parameters p₀, p₁, p₃. Since the control unit 14 for the gap width may automatically receive the adjusted parameter values p₂, p₄, p₅ as external information, it may automatically and correctly take these into account in any subsequent adjustment. The weighting with which individual measured values are included in this calculation may be set to decrease with the age of the measured values so that new measured values, which may have a greater probability of being representative of the current processing properties of the harvested material, influence the result more than older ones.

It may not be necessary to wait for an adjustment of the characteristic map until three or more measured values are available as described above. Equivalent to the above-described procedure for establishing the corrected setting P₂ is, for example, to immediately and automatically correct the parameter p₀ when the measured value C₁ is available so that the formula correctly predicts the measured value C₁, i.e. in the above-described case, to reduce p₀ by 5% and then to determine P₂ using the corrected formula.

In the above-described method, the calculation of the parameters p₀, . . . , p₅ may be based entirely on the measurements of the CSPS recorded during ongoing use of the forage harvester as soon as the number of measured values is sufficient to automatically perform the necessary calculations. As a result, each individual measured value may have a high influence on the optimization result, and individual measurement errors may lead to an incorrect parameter set being calculated which, when it used to control the rotational speed and gap width, will result in a CSPS value that grossly deviates from the expected one.

It may be assumed that a parameter set is incorrect, for example, if the CSPS value automatically calculated using the parameter values decreases with an increasing gap width CC or increasing rotational speed n_{HT}. In order to intercept such events, among other things, it may be provided that the control unit 14 automatically recognizes as incorrect an optimization result in which one of the parameters p₀, . . . , p₅ has changed its sign compared to a previous one, or in which the change in one of the parameters exceeds a permissible upper limit. If such an incorrect result occurs, the control unit 14 may automatically continue to use the set of parameter values p₀, . . . , p₅ obtained during the previous optimization and automatically discard measured values added since the calculation of this set; another option may be to automatically and completely discard the CSPS measured values obtained over the course of the current use of the forage harvester, automatically return to the parameter values p₀*, . . . , p₅* specified by the manufacturer, and automatically restart the above-described procedure.

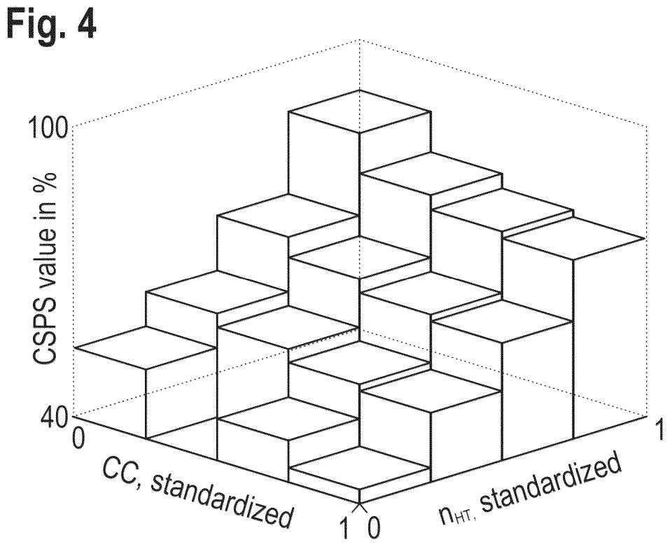

In one or some embodiments, the manufacturer does not specify a set of parameter values p₀*, . . . , p₅*, but rather a database of pairs of values for the rotational speed n_{HT} and the gap width CC and CSPS values measured for these pairs of values. FIG. 4 shows an example of such a database as a three-dimensional diagram. The setting ranges of the gap width CC and the rotational speed n_{HT} may be divided into m₁ and m₂ intervals of equal size. In FIG. 4, m₁=m₂=4, realistic values may be up to 20, and M1=10 or M2=10 may be used. The two-dimensional adjustment range spanned by the gap width CC and the rotational speed n_{HT} may thus be divided into n1*n2 sub-intervals. If the gap width CC and the rotational speed n_{HT} may each be set in an interval [0.1] in (arbitrary units), then the centers of the subintervals may form a regular grid at the coordinate values of 0.5/m₁, 1.5/m₁, . . . , (m₁-0.5)/m₁ of the gap width and 0.5/m₂, 1.5/₂, . . . , (m₂-0.5)/m₂ of the rotational speed. For each of these sub-intervals, a maximum of one initial measured value recorded by the manufacturer may be saved, which may determine the height of a cuboid at the location of this sub-interval in FIG. 4. There may also be sub-intervals for which no initial measured value is saved, shown in FIG. 4 by a missing cuboid at the location of the sub-interval.

A set of original parameter values p₀*, . . . , p₅* derived from this database may be stored in the control unit 18 or derived by it from the database at the start of each use of the forage harvester as described above.

If the forage harvester reaches a stationary state during operation (e.g., if changes in gap width CC, rotational speed n_{HT} and CSPS value remain within an interval of e.g. +/−5% around their value at the beginning of the time period), then the control unit 18 may automatically identify the subinterval of the setting range in which the current value pair of the gap width CC and rotational speed n_{HT} lies, and may automatically overwrite the initial measured value assigned to this subinterval using the CSPS value measured in this stationary state. In the simplest case, the initial measured value may simply be automatically overwritten with the new measured value; however, it is also contemplated to first automatically calculate an expected CSPS value for the current value pair of the gap width CC and rotational speed n_{HT} from the saved initial measured values, to automatically determine the difference between this and the measured CSPS value, and then to automatically correct the CSPS value saved for the subinterval by this difference. An updated set of parameters p₀, . . . , p₅ may then be automatically calculated using the saved CSPS values changed in this way according to the same procedure as before.

Whereas in the embodiment described first, the parameters p₀, . . . , p₅ were completely and automatically recalculated based on the measured values by CSPS obtained during ongoing use as soon as the number of measured values permitted this. Alternatively, the initial measured values of a subinterval may remain significant for the calculation of the parameters as long as no more recent measured value is available for the relevant subinterval. This may reduce the influence that a single faulty measurement may have on the parameter set resulting from the calculation. This may also reduce the probability that the calculation will deliver a recognizably incorrect result. If this does happen, the same results as described above may be delivered. If this does in fact happen, the same interception measures as described in the first embodiment are applicable.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Forage harvester
2 Body
3 Attachment
4 Feed roller
5 Cutterhead
6 Cutting edge
7 Cracker roller
8 Postaccelerator
9 Discharge chute
10 Camera
11 Onboard computer
12 Image processing unit
13 Optimization unit
14 Control unit
15 Processor
16 Memory

1. A self-propelled forage harvester comprising:
a cutterhead configured to be driven at a rotational speed that is variable, wherein the cutterhead is configured to chop harvested material;
a cracker roller pair with a gap width that is variable, the cracker roller pair being positioned behind the cutterhead on a path of the harvested material through the forage harvester and configured to comminute grains in the chopped harvested material; and
a control unit configured to:
access a characteristic map, wherein the characteristic map describes a corn silage processing score (CSPS) depending on at least the rotational speed and the gap width;
determine, based on the characteristic map, a value for the rotational speed and a value for the gap width; and
control the cutterhead based on the value for the rotational speed and the cracker roller pair based on the value for the gap width.

2. The self-propelled forage harvester of claim 1, wherein the control unit is configured to automatically adjust the rotational speed and the gap width to match a target value of the CSPS using the characteristic map.

3. The self-propelled forage harvester of claim 2, wherein the control unit is configured, responsive to automatically determining an at least predetermined deviation between the target value and an actual value of the CSPS, to:
initially change the gap width in a direction for which a reduction in the at least predetermined deviation is to be expected based on the characteristic map; and
thereafter change the rotational speed only responsive to determining that the gap width has reached a limit of its setting range.

4. The self-propelled forage harvester of claim 1, further comprising an image processing unit in communication with a camera positioned in path of the harvested material positioned behind the cracker roller pair; and
wherein the image processing unit is configured to determine an actual value of the CSPS from one or more images of the harvested material generated by the camera.

5. The self-propelled forage harvester of claim 4, wherein the image processing unit configured to:
determine at least one dimension of particles depicted in the one or more images; and
using the at least one dimension, determine the actual value of the CSPS.

6. The self-propelled forage harvester of claim 4, wherein the image processing unit is configured to determine the actual value of the CSPS by identifying a correlation of a particle with a size fraction relevant for determining the actual value of the CSPS.

7. The self-propelled forage harvester of claim 1, wherein the control unit is configured to optimize the characteristic map based on one or more deviations between a CSPS value predicted by the characteristic map for a respective value pair of the rotational speed and the gap width and a CSPS value measured for the respective value pair.

8. The self-propelled forage harvester of claim 7, wherein the control unit is configured to use a measured CSPS value for optimizing the characteristic map only if the measured CSPS value was measured during a quasi-stationary state of the forage harvester; and
wherein the quasi-stationary state is characterized in that in a specified period of time, which is longer than a dwell time of the harvested material in the forage harvester, changes in the rotational speed, the gap width and the CSPS value are smaller than a specified relative fluctuation range.

9. The self-propelled forage harvester of claim 1, wherein the characteristic map is defined by a multi-parameter function of at least: the rotational speed; the gap width; and a set of values of the parameters of the multi-parameter function; and
further comprising an optimization unit configured to optimize the set of parameter values based on a database of respective pairs of values of the rotational speed and the gap width and CSPS values measured for the respective pairs of values, with the optimization unit configured to minimize a deviation between an actual value of the CSPS and a value of the CSPS expected based on the characteristic map.

10. The self-propelled forage harvester of claim 9, wherein a respective value pair of the rotational speed and the gap width assumed during operation define a respective two-dimensional setting range;
wherein the respective value pairs of the database define a point grid in the two-dimensional setting ranges; and
wherein, if a measured CSPS value is available for a value pair of the rotational speed and the gap width that does not correspond to any point of the point grid, the point of the grid closest to the value pair is determined, and the CSPS value of the database assigned to the point is overwritten using the measured CSPS value.

11. The self-propelled forage harvester of claim 10, wherein the multi-parameter function comprises a second-order polynomial in the rotational speed and the gap width.

12. The self-propelled forage harvester of claim 10, wherein the multi-parameter function comprises a number of parameters; and
wherein the optimization unit, responsive to determining that a number of available value pairs of measured and expected values of the CSPS is smaller than the number of parameters of the multi-parameter function, is configured to perform an initial optimization.

13. A method for operating a forage harvester comprising:
accessing a multi-parameter function of at least a rotational speed of a cutterhead, a gap width of a cracker roller pair, and an original set of parameter values which define an original characteristic map of a corn silage processing score (CSPS) depending on at least the rotational speed and the gap width;
determining an actual value of the CSPS for actual values of the rotational speed and the gap width;
replacing the original set of parameter values with an optimized set in order to generate an updated characteristic map, wherein the parameter values of the optimized set are selected such that deviation between the actual value of the CSPS and a value expected based on the characteristic map is smaller when using the optimized parameter values than when using the original parameter values; and
using the updated characteristic map in order to automatically control operation of the forage harvester.

14. The method of claim 13, wherein the forage harvester includes a control unit; and
wherein the control unit:
automatically determines, based on the updated characteristic map, a value for the rotational speed and a value for the gap width; and
automatically controls the cutterhead based on the value for the rotational speed and the cracker roller pair based on the value for the gap width.

15. The method of claim 14, wherein the control unit automatically adjusts the rotational speed and the gap width to match a target value of the CSPS using the updated characteristic map.

16. The method of claim 15, wherein the control unit, responsive to automatically determining an at least predetermined deviation between the target value and an actual value of the CSPS:
initially changes the gap width in a direction for which a reduction in the at least predetermined deviation is to be expected based on the updated characteristic map; and
thereafter changes the rotational speed only responsive to determining that the gap width has reached a limit of its setting range.

17. A non-transient computer readable medium containing program instructions for causing a computer to perform a method of:
accessing a characteristic map, wherein the characteristic map describes a corn silage processing score (CSPS) depending on at least rotational speed of a cutterhead of a forage harvester that chops harvested material and a gap width of a cracker roller pair that is positioned behind the cutterhead on a path of harvested material through the forage harvester and that comminutes grains in the chopped harvested material;
determining, based on the characteristic map, a value for the rotational speed and a value for the gap width; and
controlling the cutterhead based on the value for the rotational speed and the cracker roller pair based on the value for the gap width.

18. The non-transient computer readable medium of claim 17, wherein the program instructions cause the computer to:
automatically adjust the rotational speed and the gap width to match a target value of the CSPS using the updated characteristic map.

19. The non-transient computer readable medium of claim 18, wherein, responsive to automatically determining an at least predetermined deviation between the target value and an actual value of the CSPS, the program instructions cause the computer to:
initially change the gap width in a direction for which a reduction in the at least predetermined deviation is to be expected based on the updated characteristic map; and
thereafter change the rotational speed only responsive to determining that the gap width has reached a limit of its setting range.

20. The non-transient computer readable medium of claim 17, wherein the program instructions cause the computer to:
receive one or more images from a camera positioned in path of the harvested material positioned behind the cracker roller pair; and
determine, from the one or more images, an actual value of the CSPS of the harvested material.
